(19) United States
(12) Patent Application Publication
(10) Pub. No.: US 2011/0096061 A1
(43) Pub. Date: Apr. 28, 2011

(54) DRIVING METHOD AND PIXEL DRIVING CIRCUIT FOR LED DISPLAY PANEL

(75) Inventors: Chen-Wei Lin, Kaohsiung City (TW); Yen-Shih Huang, Hsinchu City (TW); Ming-Hua Hsieh, Taipei County (TW); Heng-Lin Pan, Taipei County (TW)

(73) Assignee: INDUSTRIAL TECHNOLOGY RESEARCH INSTITUTE, Hsinchu (TW)

(21) Appl. No.: 12/882,215

(22) Filed: Sep. 15, 2010

(30) Foreign Application Priority Data
Oct. 26, 2009 (TW) 98136191

(51) Int. Cl. G09G 5/00; G09G 3/32

(52) U.S. Cl. 345/212; 345/82

(57) ABSTRACT

A driving method for a LED display panel time-anneals threshold voltage shifting of a driving transistor. The driving transistor has a gate terminal coupled to a data input terminal, a source terminal coupled to a cathode via a LED, and a drain terminal coupled to a system voltage. The method includes inserting a black image after an image frame is displayed. During the time period of inserting the black image, a positive voltage is applied to the cathode to turn off the LED. A negative bias from the gate terminal to the drain terminal is produced to cause voltage level of the gate terminal to be less than the source terminal.

### CROSS-REFERENCE TO RELATED APPLICATION

This application claims the priority benefit of Taiwan application serial no. 98136191, filed on Oct. 26, 2009. The entirety of the above-mentioned patent application is hereby incorporated by reference herein and made a part of this specification.

### BACKGROUND OF THE INVENTION

1. Technical Field

The present invention relates to a driving method for LED display panel. More particularly, the present invention relates to a technology to suppress the threshold voltage shifting of the driving transistor.

2. Background

The display panel can be designed in several ways. The LED (light emitted diode) display panel is one of those designs, in which the pixels can actively emit light to display the color of the image.

The pixel design of the LED display panel usually uses two transistors associating a capacitor. FIG. 1A is a drawing, schematically illustrating a conventional pixel circuit. In FIG. 1A, the LED in the pixel displays the image is usually by an organic LED (OLED), of which the gray level is determined according to the quantity of current flowing through. The transistor T1 is used as a switch, controlled by a scan signal. The data signal passes the switch transistor T1 and is connected to the gate terminal of the driving transistor T2, to turn on the driving transistor T2, which determines the quantity of the current according to the data signal, so as to generate the gray level. The capacitor is connected between the gate terminal and the drain terminal of the driving transistor T2, and the drain terminal is connected to a system voltage V_{DD}. The source terminal of the driving transistor T2 is connected to the OLED, which is further connected to a ground voltage. Since the driving transistor T2 is turned on for a long period, the threshold voltage may be shifted, resulting in the shift of the gray level accordingly. Therefore, it cannot display the gray level correctly.

In general, the capacitor and the transistor T1, serving as a switch, has less concerning on the shift in property. For the driving transistor T2 to drive the LED, the shift of threshold voltage causes the different driving currents on the LED when the same data voltage is input from the external driving IC. In concerning the situation that the light brightness of the LED is function of the conducting current, the brightness of the pixel is deviating from the original setting of the gray level as the operating period gets long.

FIG. 1B is a drawing, schematically illustrating another conventional pixel circuit. In FIG. 1B, in order to solve the foregoing issue, the circuit in FIG. 1A can be input with a clock with the same frequency as the scan lines via another transistor T3, so as to discharge the data stored in the capacitor. As a result, a certain non-driving period for the driving transistor T2 can be produced, so as to avoid the threshold voltage shifting in driving power.

In the foregoing circuit design, the additional transistor T3 needs to be added, causing fabrication difficulty and increasing cost.

### SUMMARY OF THE INVENTION

A driving method for LED display panel is introduced herein. Under the concerning without changing much in fabrication process and fabrication cost, the threshold shifting voltage of TFT (thin film transistor) can be suppressed by simply a driving method or a circuit modification.

In an embodiment of the disclosure, a driving method for driving LED display panel capable of suppressing a threshold voltage shifting of a driving transistor is provided. The driving transistor has a gate terminal coupled to a data input terminal, a source terminal coupled to a cathode via a LED, and a drain terminal coupled to a system voltage. The method includes inserting a black image after an image frame is displayed. During the time period of inserting the black image, a positive voltage is applied to the cathode to turn off the LED. A negative bias from the gate terminal to the drain terminal is produced to cause voltage level of the gate terminal to be less than the source terminal.

In an embodiment of the disclosure, a driving method of LED display panel is used to operate a driving circuit. The driving circuit comprises a driving transistor, a LED, and a maintaining capacitor. The driving transistor has a gate terminal, a drain terminal, and a source terminal, the drain terminal receiving a system voltage, the source terminal having a voltage, and the gate terminal coupled to a data input terminal. The LED is coupled between the source terminal and the cathode, wherein the cathode receives a cathode voltage signal, having a first-state voltage and a second-state voltage, the second-state voltage is higher than the first-state voltage to turn off the LED. The maintaining capacitor is coupled between the gate terminal and the drain terminal. The driving method comprises inserting a black image during an image displaying period, wherein the cathode voltage signal is changed from the first-state voltage to the second-state voltage to turn off the LED. In addition, a negative bias is produced on the maintaining capacitor from the gate terminal to the drain terminal. The gate terminal is disconnected from the data input terminal after producing the negative bias on the maintaining capacitor.

In an embodiment of the disclosure, a driving method of LED display panel is used to operate a driving circuit. The driving circuit comprises a driving transistor, a LED, an one-way conducting device, and a maintaining capacitor. The driving transistor has a gate terminal, a drain terminal, and a source terminal, the drain terminal receiving a system voltage, the source terminal having a voltage, and the gate terminal coupled to a data input terminal. The LED is coupled between the source terminal and the cathode, wherein the cathode receives a cathode voltage signal, having a first-state voltage and a second-state voltage, the second-state voltage is higher than the first-state voltage to turn off the LED. The one-way conducting device is coupled with LED in parallel, wherein an electric conducting direction of the one-way conducting device is opposite to an electric conducting direction of the LED. The maintaining capacitor is coupled between the gate terminal and the drain terminal. The driving method comprises changing the cathode voltage signal from the first-state voltage to the second-state voltage, and the second-state voltage is applied to the source terminal of driving transistor via the one-way conducting device. In addition, the cathode voltage signal is changed from the second-state voltage to the first-stage voltage.

In an embodiment of the disclosure, a pixel driving circuit of LED (light-emitting diode) display panel is disclosed. The pixel driving circuit comprises a driving transistor, a LED, and a maintaining capacitor. The driving transistor has a gate terminal, a drain terminal, and a source terminal, the drain terminal receiving a system voltage, the source terminal having a voltage, and the gate terminal coupled to a data input terminal. The LED is coupled between the source terminal and the cathode, wherein the cathode receives a cathode voltage signal, having a first-state voltage and a second-state voltage, the second-state voltage is higher than the first-state voltage to turn off the LED. The maintaining capacitor is coupled between the gate terminal and the drain terminal.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a drawing, schematically illustrating a conventional pixel circuit.

FIG. 1B is a drawing, schematically illustrating another conventional pixel circuit.

FIG. 2 is a drawing, schematically illustrating a transistor circuit, taken into consideration for investigating the threshold voltage of the driving transistor.

FIG. 3 is a drawing, schematically illustrating the variation of shifting value ΔVₜₕ with time for the threshold voltage Vₜₕ in the circuit of FIG. 2.

FIG. 4 is a drawing, schematically illustrating a driving circuit of LED display panel, according to an embodiment of the disclosure.

FIG. 5 is a drawing, schematically illustrating a waveform of operation voltage of signals with respect to the circuit in FIG. 4.

FIG. 6 is a drawing, schematically illustrating the four states in FIG. 5, according to an embodiment of the disclosure.

FIG. 7 is a drawing, schematically illustrating a driving circuit for LED display panel, according to an embodiment of the disclosure.

FIG. 8 is a drawing, schematically illustrating the voltage waveform of the driving signals, corresponding to two states for the circuit in FIG. 7, according an embodiment of the disclosure.

FIG. 9 is a drawing, schematically illustrating a driving circuit for LED display panel, according to an embodiment of the disclosure.

### DESCRIPTION OF THE PREFERRED EMBODIMENTS

In the disclosure, the circuit driving method for the LED display panel is introduced, capable of driving the pixel driving circuit. By the driving method, the threshold voltage shifting of the driving transistor can be suppressed. Several embodiments are provided. However, the disclosure is not limited to the embodiments. Also and, the embodiments to each other may be properly combined.

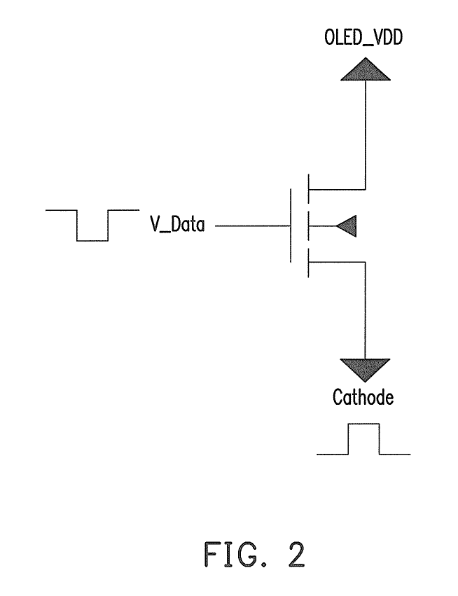

FIG. 2 is a drawing, schematically illustrating a transistor circuit of the present invention. In FIG. 2, the driving transistor taken in the embodiment can be a thin film transistor (TFT). The drain terminal of the driving transistor is coupled to a system high voltage (OLED_VDD). The gate terminal of the driving transistor is coupled to a data input terminal to receive data signal V_Data. The source terminal of the driving transistor is coupled to a cathode, for example, the source terminal is coupled to the cathode via the driven LED. The cathode terminal is not constantly connected to the ground voltage. It can be change to a positive voltage.

From the experiment, when the gate-source voltage Vgs of the driving transistor is operated at a negative voltage, it can effectively suppress the shift of the threshold voltage Vth. For testing, the voltages of V_Data signal and the cathode signal are in the range of 0-8 volts, and the operating frequency is 65 Hz.

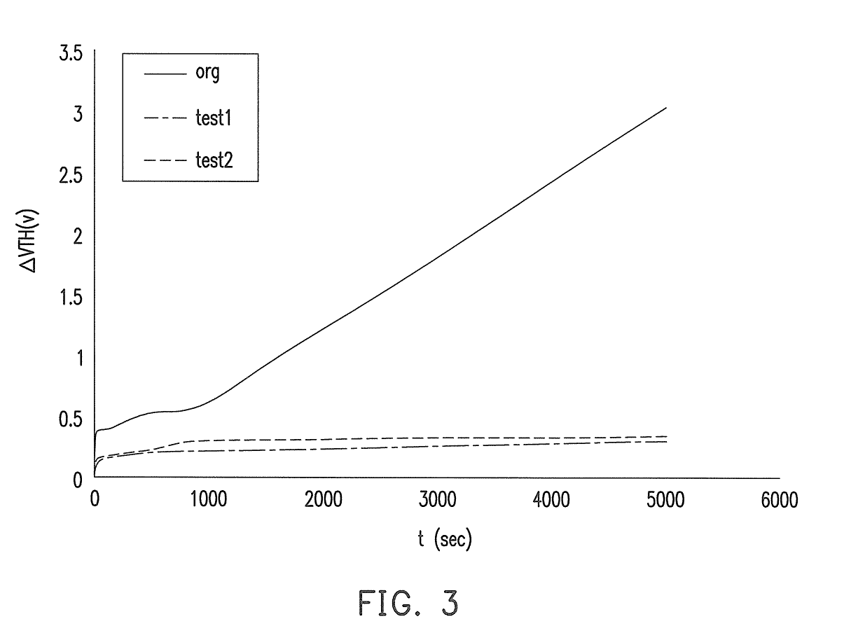

FIG. 3 is a drawing, schematically illustrating the variation of the shifting value ΔVₜₕ, with time for the threshold voltage Vₜₕ in the circuit of FIG. 2. In FIG. 3, the solid line (org) is the usual situation in connection to the ground voltage without applying negative bias. The dashed lines for test1 and test2, with respect to different tested transistors, are the situation applying the test signal waveforms to Vth. As seen in the results, the variation of the threshold voltage (Vth) is small when the signal waveform for compensation is applied. In other words, the threshold voltage of the driving transistor can be suppressed due to applying a positive voltage to the cathode terminal and then causing the voltage bias of Vgs. After this verification, the disclosure proposes a driving method for the LED display panel. Alternatively, the pixel driving circuit can also be modified in another embodiment.

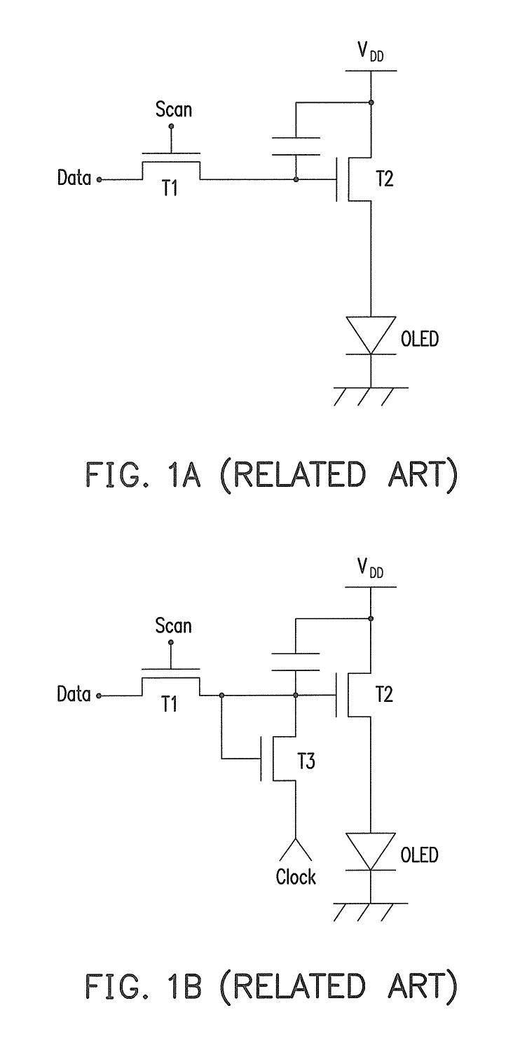

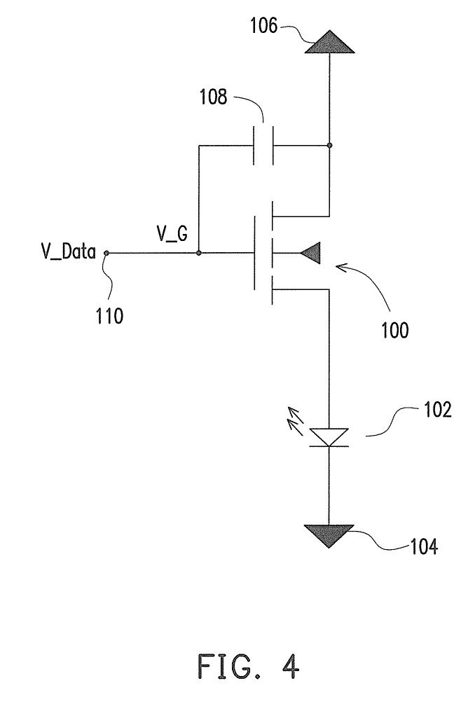

FIG. 4 is a drawing, schematically illustrating a driving circuit of LED display panel, according to an embodiment of the disclosure. In FIG. 4, the driving circuit of the LED display panel includes a driving transistor 100, a LED 102 and a maintaining capacitor 108. The driving transistor 100 has a gate terminal, a drain terminal and a source terminal. The drain terminal receives a system high voltage 106, such as VDD. The source terminal has a voltage level, in accordance with the property of the transistor, approaching to the threshold voltage Vth of the driving transistor 100. The gate terminal having a voltage V_G is coupled to the data input terminal 110 to receive the data signal V_data. Herein, a switch transistor T1 controlled by the scan signal, as shown in FIG. 1, is implemented between the gate terminal and the data input terminal 110, as to be known by those with ordinary skill in the art, and is not further described in detail.

In addition, the LED 102 is connected between the source terminal and the cathode terminal 104. It is noted that the cathode terminal 104 receives a cathode voltage signal, which is not constantly at the ground voltage. Instead, it has a first-state voltage and a second-state voltage. The second-state voltage is higher than the first-state voltage and is activated at a predetermined time period to turn off the LED. Further, the maintaining capacitor 108 is connected between the gate terminal and the drain terminal of the driving transistor 100.

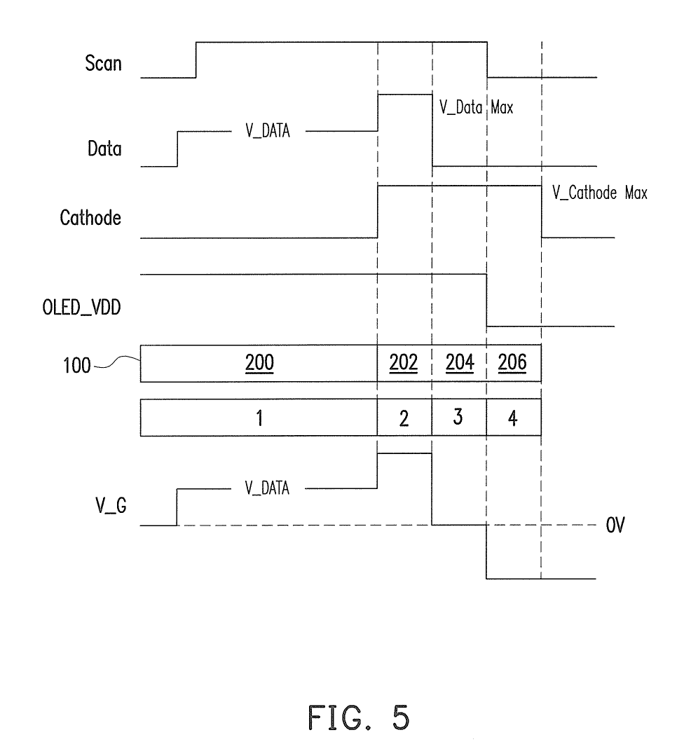

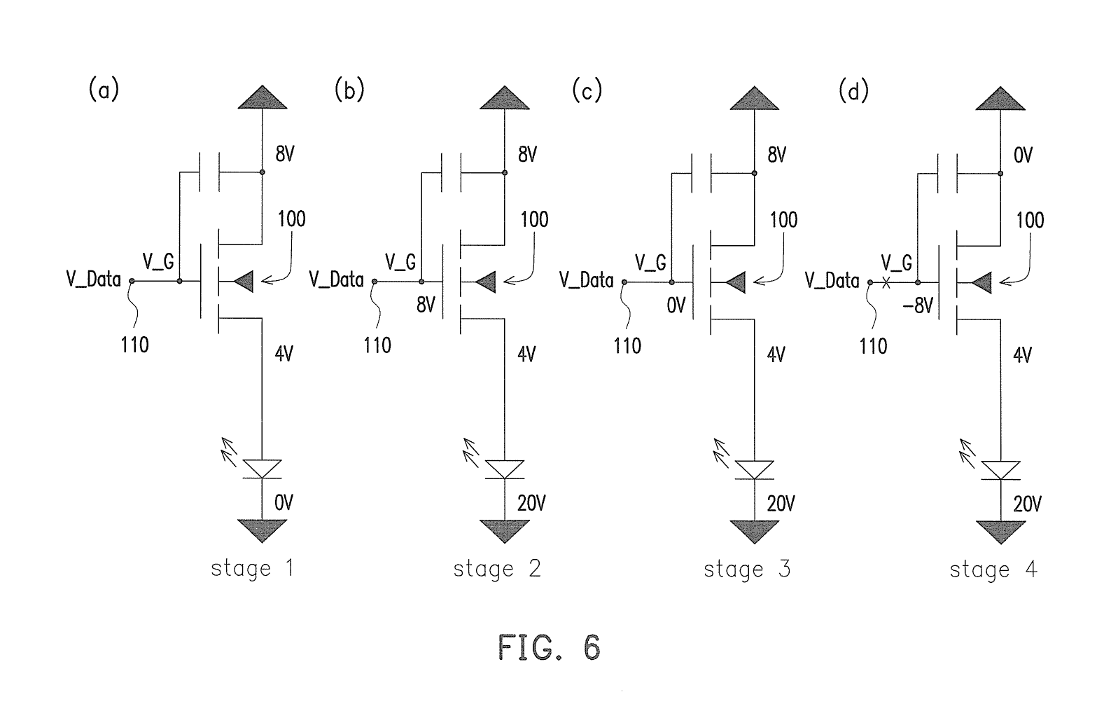

The operation mechanism is described as follows. FIG. 5 is a drawing, schematically illustrating a waveform of operation voltage of signals with respect to the circuit in FIG. 4. FIG. 6 is a drawing, schematically illustrating the four states in FIG. 5. In FIG. 5 and FIG. 6, when shifting of the threshold voltage is to be suppressed, a black image is inserted. The black image means that there is no image data output. The suppression of the threshold voltage shifting in the period of black image does not affect the content of the displayed image. Since the time period of the black image is rather short, it does not effectively cause the reaction to the eye, so that the image quality can substantially remain without effect. The brightness may have slight change but not cause the performance of the image brightness. The time to insert the black image is flexible, such as once for every several image frames. In the embodiment, for example, the black image may be inserted at the end of each image frame.

The operation stages for the driving transistor 100 can be divided into four periods 200, 202, 204, 206, or stages 1 to 4. Period 200 is the normal displaying state. The gate terminal of the driving transistor 100 receives the data signal V_Data of the image. The voltage V_G is changing in accordance with the data signal V_Data. The variation of the gate voltage with respect to the four stages is shown as the signal V_G.

In stage 1, the voltage at the cathode terminal remains at the ground voltage, such as 0V. In corresponding to FIG. 6(a), the gate terminal of the driving transistor 100 receives the data signal V_Data via the data input terminal 110. The drain terminal of the driving transistor 100 is at the system high voltage, such as 8V. The voltage of the source terminal of the driving transistor 100 is substantially at a voltage level, such as 4V, usually close to the threshold voltage of the LED 102.

In order to avoid the error of image display, the LED 102 is turned off, that is inserting a black image by applying a positive voltage at the cathode terminal, higher than the source voltage, such as a V_cathode Max at the highest positive voltage level, or 20V in the example. The voltage of the cathode terminal causes the reverse bias on the LED, and then turns off the LED. The voltage at 20V is far higher than the source voltage at 4V to avoid the leakage current on the LED.

The period for inserting the black image is also divided in three stages as stage 2, stage 3 and stage 4, indicated in time periods 202, 204, and 206. The voltage state in stage 2 can be referred to FIG. 6(b). In stage 2, the data signal V_Data at the data input terminal 110 is raised to a positive voltage, such as the system high voltage, or 8V. This is the maximum for the system voltage, for example, as indicated as V_Data Max. in FIG. 5 This is to produce the maximum drain voltage and the effect is also causing discharge for the maintaining capacitor, resulting in zero bias.

In stage 3, also referring to FIG. 6(c), the voltage of the data signal V_Data is changed to 0V. At this moment, the voltage bias Vgs in this embodiment is Vgs=−4V. In this manner, the negative bias has been achieved by at a certain level, capable of adjusting and suppressing the threshold voltage shifting of the driving transistor 100. However, the way to set the voltage of the data signal V_Data to 0V is just one embodiment. If the negative voltage is applied, the voltage bias Vgs becomes larger. However, the 0V is rather simple and does not consume power.

In stage 4, also referring to FIG. 6(d), the data input terminal 110 of the driving transistor 100 is disconnected, indicated by x. The disconnection of the data input terminal 110 of the driving transistor 100 can be done by using the scan signal to turn off the switch transistor, resulting in not conducting state. As a result, the gate terminal, connected to the maintaining capacitor, becomes a floating state. In addition, voltage of the drain terminal is also changed from the system high voltage to the zero voltage. At this moment, since the maintaining capacitor maintains the voltage bias, the gate terminal in voltage is pulled to the negative voltage level, such as −8V. In this stage 4, since it just needs to change the voltage to 0V, the response is fast. The bias Vgs is then Vgs=(−8V)−(4V)=−12V. In comparison to stage 3 with Vgs=−4V, the larger negative bias, Vgs=−12V, can be achieved. The suppressing effect on the threshold voltage is larger.

For the diving method in another embodiment, the negative bias is produced due to the maintaining capacitor connected between the gate terminal and the drain terminal. The applied voltages on the drain terminal and the gate terminal can maintain the negative bias. In other words, the disclosure in the embodiment does not modify the conventional design in circuit with the maintaining capacitor. The operation voltages are just the example. The principle is applying the voltage to produce the negative bias for the Vgs in sufficient level to compensate the threshold voltage of the driving transistor during inserting the black image. The manner is not limited to the specific choice.

Further, the LED being driven can be organic LED (OLED) or the polymer LED (PLED).

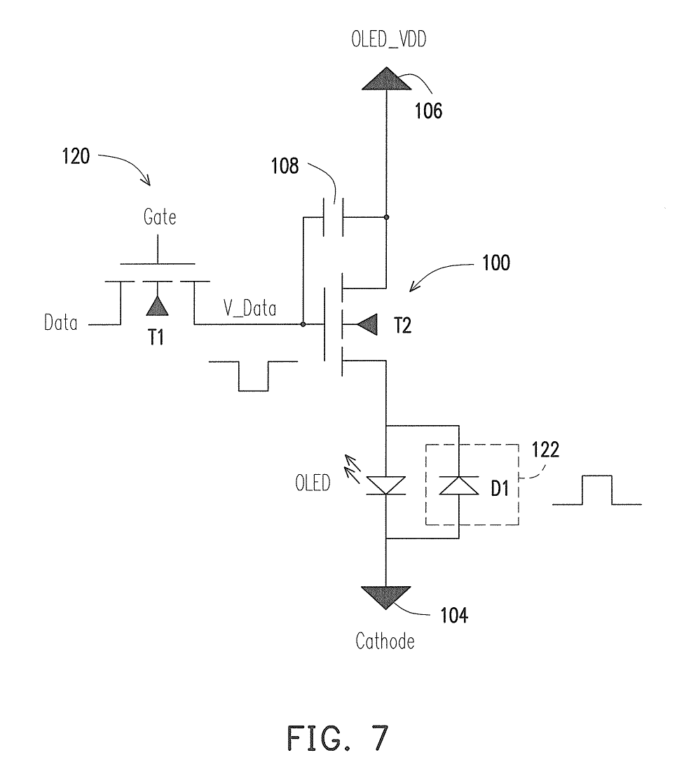

In further embodiments, in order to get the negative bias for Vgs, the pixel driving circuit can be modified. FIG. 7 is a drawing, schematically illustrating a driving circuit for LED display panel, according to an embodiment of the disclosure. In FIG. 7, the pixel driving circuit is modified, based on the circuit in FIG. 4, by adding an one-way conducting device 122, coupled with the OLED in parallel. The one-way conducting device 122, such as a usual diode, has the reverse conducting direction. In this circuit, when the cathode terminal 104 is applied a positive voltage, the positive voltage can directly passed to the source terminal of the driving transistor 100, to produce the negative bias for Vgs. The OLED does not emit light in when the positive voltage is applied to the cathode terminal 104, resulting in inserting black image.

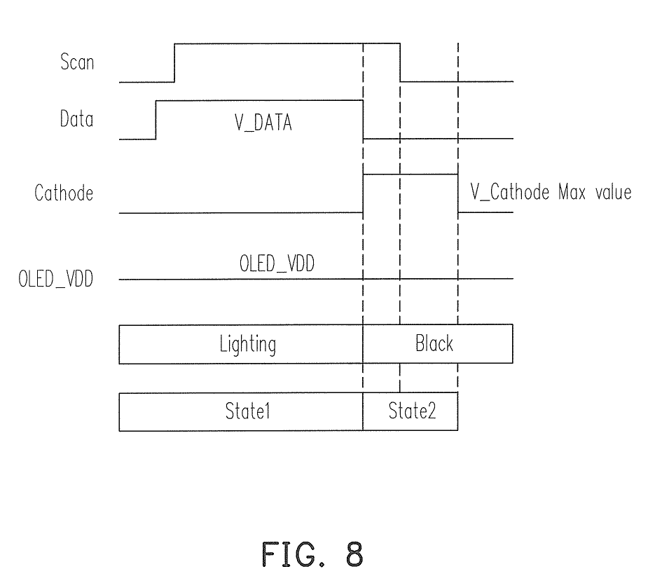

FIG. 8 is a drawing, schematically illustrating the voltage waveform of the driving signals, corresponding to two states for the circuit in FIG. 7, according an embodiment of the disclosure. In FIG. 8, the driving method based on the circuit in FIG. 7 can be simplified. When the black image is inserted, the cathode voltage signal at the cathode terminal, as previously described, is changing from the ground voltage to the positive voltage, such as the maximum positive voltage, V_Cathode Max value. The data signal V_Data and the scan signal have the same effect with the effect in FIG. 6. In other words, the modified circuit allows the positive voltage at the cathode terminal to be directly transmitted to the source terminal of the driving transistor. The simplified driving method is also to get the negative bias for the Vgs.

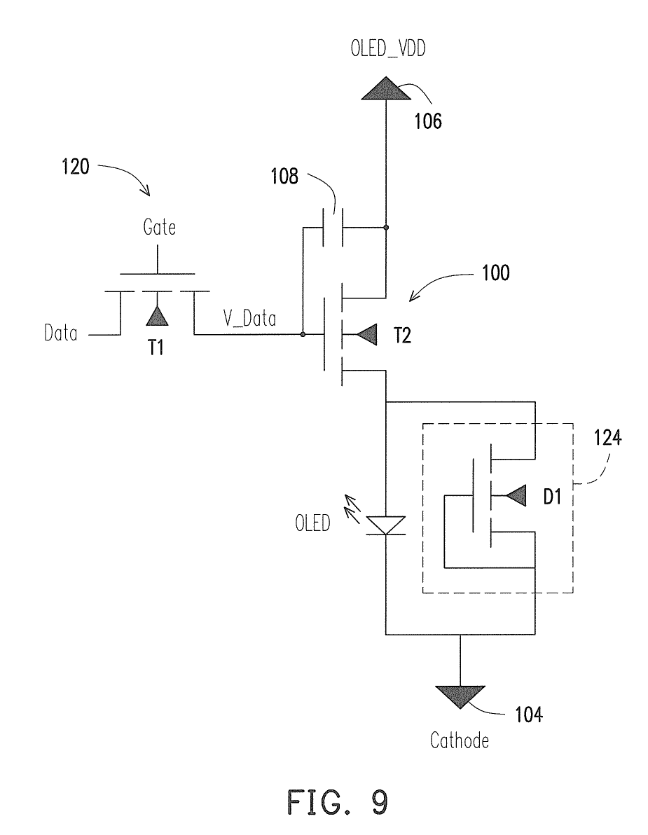

FIG. 9 is a drawing, schematically illustrating a driving circuit for LED display panel, according to an embodiment of the disclosure. In FIG. 9. the one-way conducting device 122 in FIG. 7 can be replaced by the one-way conducting device 124, which is formed by a transistor, of which the gate terminal and the source terminal are connected together to the cathode terminal 104. The field effect transistor is then operated as a diode. In other words, the one-way conducting device can be designed in other manners, without restricting to the usual diode.

It will be apparent to those skilled in the art that various modifications and variations can be made to the structure of the present invention without departing from the scope or spirit of the disclosure. In view of the foregoing descriptions, it is intended that the present invention covers modifications and variations of this invention if they fall within the scope of the following claims and their equivalents.

What is claimed is:

1. A driving method of LED (light-emitting diode) display panel, to suppress threshold voltage shifting of a driving transistor, the driving transistor having a gate terminal coupled to a data input terminal, a source terminal coupled to a cathode via a LED, and a drain terminal coupled to a system voltage, the method comprising:
inserting a black image after an image frame is displayed;
during a time period of inserting the black image, a positive voltage is applied to the cathode to turn off the LED; and
producing a negative bias from the gate terminal to the source terminal, causing a voltage level of the gate terminal to be less than a voltage level of the source terminal.

2. The method of claim 1, wherein the step of producing the negative bias is performed via a maintaining capacitor coupled between the drain terminal and the gate terminal for maintaining the negative bias, which is a result from voltages applied at the drain terminal and the gate terminal.

3. The method of claim 2, wherein a last stage for producing the negative bias further disconnecting the gate terminal and a voltage of the drain terminal is less than the system voltage.

4. The method of claim 3, wherein in the voltage of the drain terminal at the last stage is zero voltage.

5. A driving method of LED (light-emitting diode) display panel, used to operate a driving circuit, the driving circuit comprising:
a driving transistor, having a gate terminal, a drain terminal, and a source terminal, the drain terminal receiving a system voltage, the source terminal having a voltage, and the gate terminal coupled to a data input terminal;
a LED, coupled between the source terminal and a cathode, wherein the cathode receives a cathode voltage signal, having a first-state voltage and a second-state voltage, the second-state voltage is higher than the first-state voltage to turn off the LED; and
a maintaining capacitor, coupled between the gate terminal and the drain terminal;
the driving method comprising:
inserting a black image during an image displaying period, wherein the cathode voltage signal is changed from the first-state voltage to the second-state voltage to turn off the LED;
producing a negative bias on the maintaining capacitor from the gate terminal to the drain terminal; and
disconnecting the gate terminal from the data input terminal after producing the negative bias on the maintaining capacitor.

6. The method of claim 5, wherein when the gate terminal disconnects form the data input terminal, the system voltage is changed to zero voltage.

7. The method of claim 5, wherein the step of disconnecting the gate terminal from the data input terminal uses a switching transistor, which is controlled by a scan signal.

8. The method of claim 5, wherein the step of inserting the black image comprises a first stage, a second stage, and a third stage, to perform the following steps:
in the first stage, inputting a high-level voltage at the data input terminal, to let the maintaining capacitor be at a smallest bias;
in the second stage, inputting a low-level voltage at the data input terminal, to produce the negative bias on the maintaining capacitor; and
in the third stage, disconnecting the data input terminal from the gate terminal and changing the drain terminal from the system voltage to a smaller voltage, wherein the maintaining capacitor still remains at the negative bias.

9. The method of claim 8, wherein the drain terminal is at zero voltage in the third stage.

10. The method of claim 9, wherein the low-level voltage inputted to the data input terminal in the second stage is zero voltage.

11. The method of claim 8, wherein the cathode voltage signal is zero voltage at the first stage.

12. The method of claim 8, wherein a voltage level of the cathode voltage signal at the second stage has a lower limit to avoid a leakage current on the LED and a upper limit to avoid a breakdown of the LED.

13. The method of claim 5, wherein the step of inserting the black image is taken according to a predetermined time period.

14. The method of claim 5, wherein a frequency for inserting the black image is changed under a programmable control.

15. The method of claim 5, wherein the first-state voltage is zero voltage and the second-state voltage is a positive voltage.

16. A driving method of LED (light-emitting diode) display panel, used to operate a driving circuit, the driving circuit comprising:
a driving transistor, having a gate terminal, a drain terminal, and a source terminal, the drain terminal receiving a system voltage, the source terminal having a voltage, and the gate terminal coupled to a data input terminal;
a LED, coupled between the source terminal and a cathode, wherein the cathode receives a cathode voltage signal, having a first-state voltage and a second-state voltage, the second-state voltage is higher than the first-state voltage to turn off the LED;
an one-way conducting device, coupled with LED in parallel, wherein an electric conducting direction of the one-way conducting device is opposite to an electric conducting direction of the LED; and
a maintaining capacitor, coupled between the gate terminal and the drain terminal;
the driving method comprising:
changing the cathode voltage signal from the first-state voltage to the second-state voltage, and the second-state voltage is applied to the source terminal of driving transistor via the one-way conducting device; and
changing the cathode voltage signal from the second-state voltage to the first-stage voltage.

17. The method of claim 16, further comprising:
disconnecting the gate terminal from the data input terminal when the cathode voltage signal is at the second-state voltage.

18. The method of claim 16, wherein the first-state voltage is zero voltage and the second-state voltage is a positive voltage.

19. The method of claim 16, wherein when the cathode voltage signal at the second-state voltage, the gate terminal is disconnect from the data input terminal.

20. A pixel driving circuit of LED (light-emitting diode) display panel, comprising:
a driving transistor, having a gate terminal, a drain terminal, and a source terminal, the drain terminal receiving a system voltage, the source terminal having a voltage, and the gate terminal coupled to a data input terminal;
a LED, coupled between the source terminal and the cathode, wherein the cathode receives a cathode voltage signal, having a first-state voltage and a second-state voltage, the second-state voltage is higher than the first-state voltage to turn off the LED;
an one-way conducting device, coupled with LED in parallel, wherein an electric conducting direction of the one-way conducting device is opposite to an electric conducting direction of the LED; and
a maintaining capacitor, coupled between the gate terminal and the drain terminal.
